(19) United States
(12) Patent Application Publication
(10) Pub. No.: US 2026/0121876 A1
(43) Pub. Date: Apr. 30, 2026

(54) BLOCKCHAIN PROCESSING WITHIN A VEHICLE USING SURPLUS BATTERY CHARGING ENERGY

(71) Applicant: FCA US LLC, Auburn Hills, MI (US)

(72) Inventor: Andrew D. Johnson, Auburn Hills, MI (US)

(21) Appl. No.: 18/926,501

(22) Filed: Oct. 25, 2024

(51) Int. Cl. H04L 9/00; B60R 16/033; H02J 7/00

(52) U.S. Cl. CPC H04L 9/50; B60R 16/033; H02J 7/865

(57) ABSTRACT

A system to use available energy from a vehicle charging system to power blockchain processing. The system may determine that a charge cycle for charging a vehicle battery is occurring, determine an amount of available energy at least in part from an energy generator, and determine an energy target at least in part based on a charge level of the vehicle battery to be achieved during the charge cycle. Further, the system may compare the amount of available energy to the energy target, and power one or more blockchain processors to perform blockchain processing when the available energy meets or exceeds the energy target.

### FIELD

The present disclosure relates to blockchain processing within a vehicle.

### BACKGROUND

Charging systems may be used to charge a battery of a vehicle. However, if the battery is fully charged or above a predetermined level of charge, continued use of the charging system may subject the battery to overcharging. Vehicles or chargers may adjust the amount of current received by the vehicle battery based on the battery's current charge status. Therefore, when using chargers having an energy surplus or chargers that continue to produce energy regardless of whether the vehicle is connected or not, energy is wasted or goes unused when the battery is fully charged or above a predetermined level of charge

### SUMMARY

In at least some implementations, a method for using available energy from a vehicle charging system to power blockchain processing includes determining that a charge cycle for charging a vehicle battery is occurring, determining an amount of available energy at least in part from an energy generator, determining an energy target at least in part based on a charge level of the vehicle battery to be achieved during the charge cycle, comparing the amount of available energy to the energy target, and powering one or more blockchain processors to perform blockchain processing when the available energy meets or exceeds the energy target.

In at least some implementations, the available energy includes stored energy from the energy generator and an amount of energy that is determined will be generated by the energy generator during the charge cycle.

In at least some implementations, the energy target includes an amount of energy required to perform at least some blockchain processing in addition to the energy needed to charge the vehicle battery to the charge level to be achieved during the charge cycle.

In at least some implementations, the energy generator is a renewable energy source including one or more of a solar panel, a wind turbine, a hydro-electric turbine, a tidal generator, and a wave energy convertor.

In at least some implementations, the energy generator is coupled to a vehicle battery charger or to an energy storage device that is coupled to the vehicle battery charger.

In at least some implementations, powering one or more blockchain processors to perform blockchain processing includes using power from the energy generator to power the one or more blockchain processors.

In at least some implementations, the energy generator is carried by the vehicle.

In at least some implementations, the energy generator is separate from the vehicle and is selectively brought into electric communication with the vehicle battery.

In at least some implementations, powering one or more blockchain processors to perform blockchain processing includes using power from the vehicle battery to power the one or more blockchain processors.

In at least some implementations, performing blockchain processing includes collecting unconfirmed transactions from a network, organizing transactions into a new block, referring to previous block creating chain of blocks, and producing a hash that meets specific criteria of a blockchain.

In at least some implementations, a system for a vehicle includes a blockchain processor, a vehicle battery adapted to be charged with electrical power from a vehicle battery charger, a control system communicated with the vehicle battery to control, at least in part, charging of the vehicle battery, the control system includes one or more processors, memory and instructions or programs stored in the memory or otherwise accessible by the processors that is capable of communicating with a network configured to transmit and receive blockchain data. Wherein the blockchain processor is either integrated with the controller or separate from the controller and is capable of communicating with the controller to determine that a charge cycle for charging the vehicle battery is occurring determine an amount of available energy at least in part from an energy generator determine an energy target at least in part based on a charge level of the vehicle battery to be achieved during the charge cycle, compare the amount of available energy to the energy target, and power the blockchain processor to perform blockchain processing when the available energy meets or exceeds the energy target.

In at least some implementations, the control system is adapted to communicate with the vehicle battery charger, and wherein the available energy includes stored energy available to the vehicle battery charger and an amount of energy that is determined will be generated by an energy generator coupled to the vehicle battery charger during the charge cycle.

In at least some implementations, the energy target includes an amount of energy required to perform at least some blockchain processing in addition to the energy needed to charge the vehicle battery to the charge level to be achieved during the charge cycle.

In at least some implementations, the energy generator is a renewable energy source including one or more of a solar panel, a wind turbine, a hydro-electric turbine, a tidal generator, and a wave energy convertor.

In at least some implementations, the energy generator is coupled to the vehicle battery charger or to an energy storage device that is coupled to the vehicle battery charger.

In at least some implementations, powering one or more blockchain processors to perform blockchain processing includes using power from the vehicle battery charger to power the one or more blockchain processors.

In at least some implementations, the energy generator includes one or both of a solar panel or a wind turbine, and the energy generator is carried by the vehicle.

In at least some implementations, powering one or more blockchain processors to perform blockchain processing includes using power from the vehicle battery to power the one or more blockchain processors.

In at least some implementations, the energy generator is dedicated at least in part to the vehicle battery charger.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic of a system that enables blockchain processing within a vehicle using surplus energy;

FIG. 2 is another schematic of a system that enables blockchain processing within a vehicle using surplus energy; and

FIG. 3 shows a flow chart for a method for performing blockchain processing within a vehicle using surplus energy.

### DETAILED DESCRIPTION

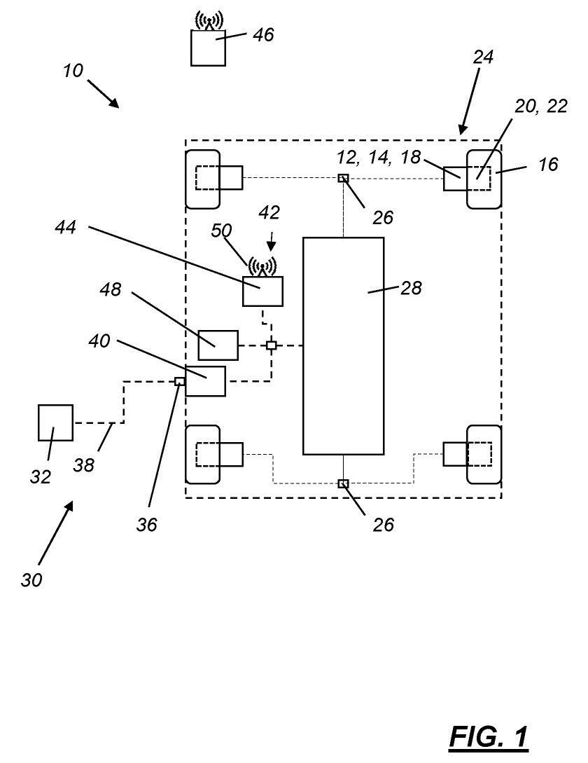

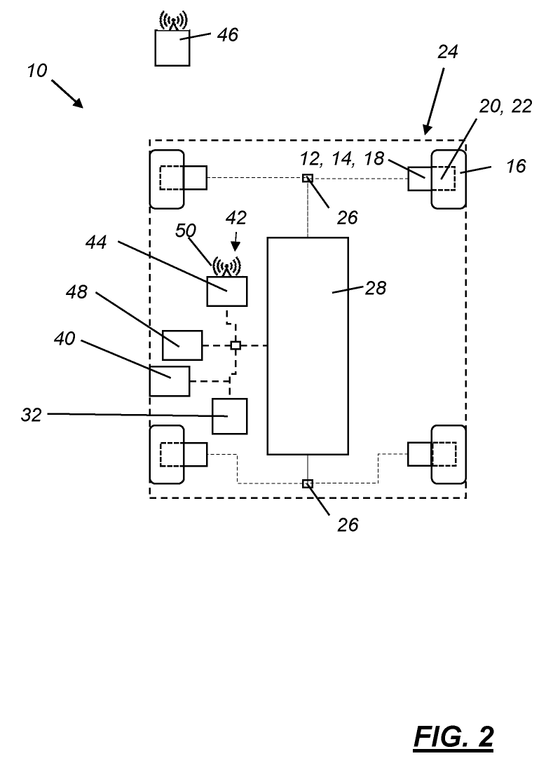

Referring in more detail to the drawings, FIGS. 1-2 illustrate a vehicle 10 having a propulsion system 12 including a prime mover 14 coupled to multiple wheels 16 to propel the vehicle 10. The prime mover 14 could be an electric motor 18, a combustion engine, or both, as desired. Further, with electric motors 18, one or more motors 18 may be used to power individual axles/shafts or wheels 16, as desired. To slow and stop the vehicle 10, the vehicle 10 includes a primary braking system 20. The primary braking system 20 includes multiple brake assemblies 22, each associated with a different one and up to each wheel 16 of the vehicle 10. The brake assemblies 22 may be friction brakes of known types. Further, the vehicle 10 may include a regenerative braking system 24.

The regenerative braking system 24 may include one or more electric motors 18, an inverter 26, and a battery 28. There may be one or multiple batteries 28 in a vehicle 10, as desired, and for ease of description, this document will refer to the battery 28 as a singular component, without any intention to limit the disclosure to a single battery 28. The battery 28 may be mounted to or within the vehicle 10 and may be one or more interconnected cells arranged in series and/or parallel to achieve a desired voltage and capacity for energy storage. Any suitable battery composition may be used, including but not limited to lithium-ion, nickel-metal hydride, lead-acid types.

The one or more electric motors 18 may serve dual purposes of converting electrical energy to mechanical, kinetic energy to propel the vehicle 10, and to act as a generator to convert kinetic energy to electrical energy that can be stored in a suitable charge storage device such as capacitors or the vehicle battery 28 or batteries 28. Thus, when the vehicle 10 is in motion and no electricity is being supplied to the one or more electric motors 18, the kinetic energy of the vehicle 10 may be used to rotate parts of the one or more electric motors 18 to generate electricity that may be used to power electrical components and/or to charge the battery 28. One or more inverters 26 may be used to convert direct current from the battery 28 to alternating current to power the one or more electric motors 18 during regenerative braking to direct current to charge the battery 28 or for other use.

To charge the battery 28, a charging system 30 may be integrated with the vehicle 10 or separate from the vehicle 10. The charging system 30 may include an energy generator 32, and a battery charger 34 having a connector 36 and a cable 38. The energy generator 32 may be a component capable of generating electricity and may be or separate from the vehicle 10, as shown in FIG. 1, or mounted to or otherwise carried by the vehicle 10 for movement with the vehicle 10, as shown in FIG. 2. For example, the energy generator 32 may be a renewable energy source such as one or more of a solar panel, a wind turbine, a hydroelectric generator, a tidal generator, or a wave energy convertor, or a non-renewable energy source such as a gasoline powered internal combustion generator, or other energy generator or energy source, such as energy provided to the charging system 30 from a power plant.

One or more energy generators 32 may be connected to the charging system 30 to provide power to the charging system 30 for charging the vehicle battery 28. Some implementations may include a renewable energy generator, such as a windmill or wind turbine or solar panels, that are coupled to and move with the vehicle 10. Other energy generators 32 may be connected to the charging system 30, such as implementations wherein energy generated by a renewable energy generator is stored in one or more batteries that are coupled to the charging system 30 to provide electricity for charging the vehicle battery 28. In this way, in at least some implementations, a power source for the charging system 30 is either one or more renewable energy generators 32, or one or more batteries that are charged by the one or more renewable energy generators 32. In at least some implementations, the energy generator(s) 32 may be dedicated to the vehicle charging system 30, that is, used only to supply power to the vehicle charging system 30 (where dedicated means, for example, that the energy generator is not part of a community energy system or grid that supplies power to multiple homes). The energy generators 32 may provide energy to batteries or other energy storage devices that provide power only to the vehicle battery charger 34, and additional energy may be provided to other devices of, for example, a personal residence of a user, such that the energy generator is dedicated at least in part to the vehicle battery charger 34 and is not part of a community energy grid or system.

The cable 38 of the battery charger 34 is in electrical communication with both an output of the power source and the connector to transfer electrical current from the power source to the connector 36. The connector 36 is adapted to connect to a vehicle charge port 40, and may include one or more electrically conductive contacts that are in electrical communication with the energy generator 32 to transfer energy from the energy generator 32 to the battery 28 of the vehicle 10 in the form of electric current.

A vehicle control system 42 is communicated with the prime mover 14, the battery 28, and the regenerative braking system 24 to manage the power provided by the battery 28 to power the one or more electric motors 18, and the power used to charge the battery 28 from the regenerative braking system 24. Further, at least when the primary braking system 20 is a so-called brake-by-wire system, where a braking input is communicated with an electric brake actuator, the control system 42 may communicate with and control the electric brake actuator to manage the braking power provided by the primary braking system 20, in at least some implementations. The control system 42 has one or more controllers 44 or processors, memory and instructions or programs stored in the memory or otherwise accessible by the processor(s). In some implementations, the control system 42 may have or be defined by a plurality of vehicle controllers independent or networked together. Each of the controllers 44 may communicate with one or more vehicle components, system components or a network 46.

The vehicle 10 may also include a blockchain processor 48 that may be the same component as the one or more controllers 44 or processors of the control system 42, may be integrated with the control system 42, or may be a separate component from the control system 42. The blockchain processor 48 may be configured to perform blockchain mining or other blockchain processing and may have high clock speeds and multiple cores to effectively handle blockchain mining. In at least some implementations, parallel processing may be implemented by the blockchain processor 48 to divide cryptographic calculations between multiple cores of the blockchain processor 48 to complete blockchain mining. As used herein, the term blockchain processing includes blockchain mining.

Blockchain processing may include a decentralized digital ledger spread amongst a network of computers and processors configured to prevent registered transactions from being retroactively altered without the alteration of all subsequent blocks of the blockchain. For example, each block may contain a list of transactions, a timestamp, and a cryptographic hash of the previous block. The blocks are linked in chronological order, forming a blockchain. A blockchain may be distributed across a network of nodes where each node maintains a copy of the entire blockchain to ensure accuracy of each block.

To perform blockchain processing, a computer or processor performs work, often in the form of solving cryptographic puzzles or calculations to validate transactions, to obtain an award of digital currency. First the processor or computer collects data from an unconfirmed transaction from the network 46. The processor organizes transactions into a new block, competing with, or in some cases such as pool mining, assisting other mining devices to find a nonce (a random number), that when hashed with the block’s data using a cryptographic function, such as SHA-256, produces a hash that meets specific criteria. Once a valid nonce is hashed, the new block is broadcast to the network 46 for verification by other mining devices. After verification, the miner or user of the processor or computer receives a reward, usually a portion of the transaction fees associated with the transaction to be verified, or a predetermined amount of cryptocurrency in some embodiments of blockchain processing. In some networks 46, miners earn both the block reward (newly minted cryptocurrency) and transaction fees from the transactions verified in the block.

In at least some embodiments, blockchain processing includes pool mining, where resources are combined from multiple miners in a network 46 to complete a block. Pool mining increases the likelihood of completing the cryptographic calculations required to add new blocks to the blockchain by increasing the computing power available and decreasing the time to find a valid nonce, resulting in more frequent rewards that may be divided between the members of the pool based on resources used by each member.

In some embodiments, blockchain processing may include processing of vehicle data to assist in securely storing and tracking vehicle data. Vehicle data tracking on blockchain may involve, by way of non-limited examples, using blockchain technology to securely record, store, and share data related to vehicles 10 and their usage. For example, a token may be implemented in the network 46 or in the vehicle’s systems to track maintenance, service records, vehicle mileage, vehicle driving conditions, or driving history. This vehicle data may be validated by other computers or processors in blocks to form a blockchain which makes it very unlikely that the information can later be falsified.

In order to perform the functions and desired processing set forth herein, as well as the computations therefore, the control system 42 may include, but is not limited to, one or more controller(s) 44, control unit(s), processor(s), computer(s), DSP(s), memory, storage, register(s), timing, interrupt(s), communication interface(s), and input/output signal interfaces, and the like, as well as combinations comprising at least one of the foregoing. For example, the control system 42 may include input signal processing and filtering to enable accurate sampling and conversion or acquisitions of such signals from communications interfaces and sensors. As used herein the terms control system 42 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 42 may be distributed among different vehicle modules, such as an infotainment system control module, engine control module or unit, powertrain control module, transmission control module, and the like, if desired, and the memory and one or more processors may be one or both integrated into the vehicle 10 or remotely located and wirelessly communicated to the vehicle 10, as desired.

The blockchain processor 48 may be a similar controller 44 or controllers or one or more processors as set forth for the control system 42. The blockchain processor 48 may perform central processing unit (CPU), graphic processing unit (GPU) or ASIC type mining, or combinations thereof, by way of non-limiting examples.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller 44 or the like to enable control or allocate resources of a computing device.

The vehicle 10 also has a communication device 50, such as a telematics unit, having a receiver that is capable of receiving information sent wirelessly to the vehicle 10 and a transmitter capable of transmitting information wirelessly from the vehicle 10. The communication device 50 is communicated with the control system 42, and with the blockchain processor 48 to permit communication of the blockchain processor 48 with the blockchain and/or networked miners and the like, to enable the blockchain processor 48 to actively participate in the mining processes. The communication device 50 may use a cellular-based network, a satellite-based network, a city-wide WiFi-based network, or other local or wide area communication network and/or a combination thereof.

Traditionally, upon fully charging the battery 28 or reaching a predetermined charge level when vehicles 10 are being charged with energy from a power source, the vehicle 10 will stop accepting charge from the charging system 30 to protect the battery 28 from overcharging. However, the energy generator 32 will either still be generating energy or will be capable of generating energy. For example, a solar panel could still be exposed to sunlight, or a wind turbine would still be exposed to the wind even after the vehicle 10 is fully charged. Therefore, surplus energy not needed to charge the battery 28 is wasted when the battery 28 stops accepting current from the energy generator 32, or is used to charge batteries or other energy storage device(s) of the charging system 30 and is available for use.

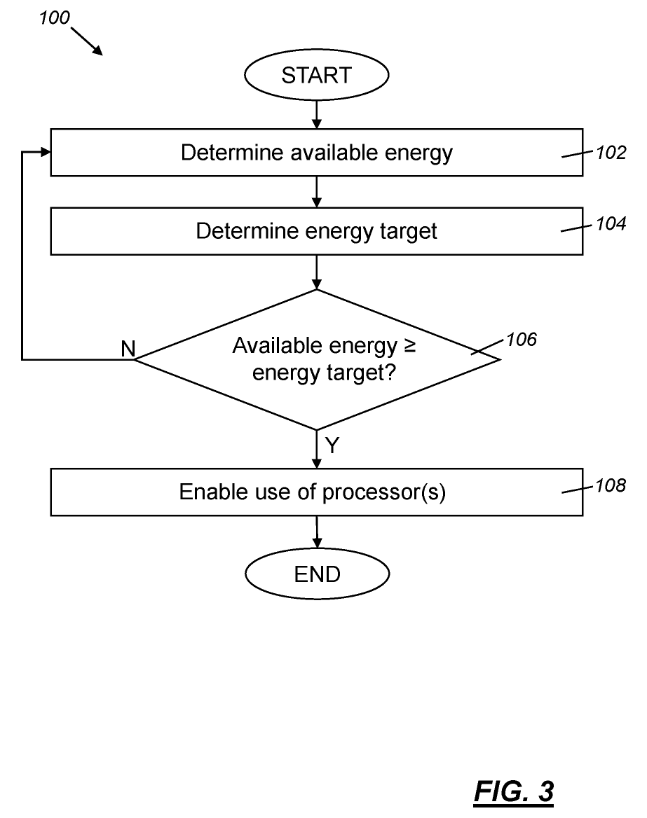

FIG. 3 depicts a method 100 for performing blockchain calculations in a vehicle 10 using energy available from the power source. In step 102, the amount of available energy is determined. The available energy may be any energy that is produced by the energy generator 32 or any energy that the energy generator 32 is capable of producing, and that is available for use during a charging cycle of the vehicle battery 28. In at least some implementations, the available energy may include energy already generated and stored at the charging system 30 and additional energy that may be generated while the vehicle 10 is being charged. In this way, a nominal charge cycle duration can be assumed (e.g. a default or standard cycle time) or determined. For example, the duration may be determined as a function of the current charge level compared to a threshold or desired charge level. Or the charge cycle duration may be entered by a user, for example, based on a time when the vehicle 10 will be driven again.

The duration of a charging event or cycle can be entered by a user into the charging system 30 or vehicle 10, or estimated or otherwise predetermined by the charging system 30 (e.g. a default setting). For example, a predetermined or nominal charging cycle may fully charge the vehicle battery 28 or charge the battery 28 to a level less than fully charged, as desired. Further, the user may set a desired battery charge level as a percent or relative amount, or as a function of an intended driving distance after the current charging cycle and before the next charging cycle. The driving distance may include one or more destinations, and map data such as a navigation program, can be used to determine projected routes of travel and the routes may be used to determine an energy use level required for the vehicle 10 to travel to the destination(s). Projected routes and destinations may also be determined by a machine learning algorithm based on data collected from previous routes (e.g. driver habits, such as going to work on certain days of the week, or to other places routinely on certain days and time, etc). The energy use level required to reach the destination(s) may be determined as a function of the distance, speed limits or typical vehicle speeds along the road, road grade (e.g. inclines and declines), traffic conditions and number of stops likely to be encountered, and this may be offset by opportunities to generate energy via the regenerative braking system 24, which may be determined based on determination of regenerative braking opportunities (slowing to stop, or to maintain speed while traveling down declines).

These are non-limiting examples of route parameters that can affect vehicle energy use and thus, the energy needed to travel along a route. The system may determine the charge cycle duration needed to achieve a certain charge level from the present battery charge level, and the duration may be used to determine an amount of additional energy generation that may be achieved by and made available from the energy generator 32 during the charge cycle.

The method 100 may also include step 104 in which an energy target is determined. The energy target may, as noted above, be determined with regard to a certain battery charge level which may include a full charge or less than a full charge, as desired. The battery charge level may be a predetermined system setting or default, or a user set level. As noted above, a desired battery charge level may be set as a percent or relative amount, or as a function of an intended driving distance after the current charging cycle and before the next charging cycle. The driving distance may include one or more destinations, and map data such as a navigation program, can be used to determine projected routes of travel and the routes may be used to determine an energy use level required for the vehicle 10 to travel to the destination(s). The energy use level required to reach the destination(s) may be determined as a function of the distance, speed limits or typical vehicle speeds along the road, road grade (e.g. inclines and declines), traffic conditions and number of stops likely to be encountered. These are non-limiting examples of route parameters that can affect vehicle energy use and thus, the energy needed to travel along a route. Routes that require higher energy use may result in an energy target that is greater (e.g. a higher battery charge level) than routes that require lower energy use. The energy target may be set to meet or exceed an expected energy use, or a certain battery level or nominal vehicle range (a range not determined as a function of a route to one or more destinations), or other target, as desired.

Next, in step 106, the available energy and the energy target can be compared to determine if the available energy is equal to or greater than the energy target. If not, the method 100 may return to step 102 to determine the available energy and energy target again, or the method 100 may end without blockchain processing or other use of the blockchain processor 48 occurring. This ensures that charging the vehicle battery 28 to the energy target is given priority over using energy to perform blockchain processing or related processing during a charge cycle. If the energy target is met during a charge cycle and the vehicle 10 is still connected to the charger 34, or if the conditions/parameters considered are changed during the charge cycle, the method 100 may again compare the then available energy with an energy target.

If the available energy at least meets the energy target, then the method 100 may continue to step 108 in which use of the blockchain processor 48 to perform blockchain processing or otherwise, is permitted. To ensure that use of the blockchain processor 48 does not consume energy that interferes with the vehicle battery charging reaching a desired level during the charge cycle, the energy target may include a buffer or threshold amount beyond the energy needed to charge the battery 28 to the desired level. That is, the energy target may include an energy level sufficient to achieve a predetermined battery charge level and also a predetermined amount of energy for blockchain processing or other blockchain processor 48 use. For example, the additional amount of energy included in the energy target may be the minimum quantity of energy required to perform blockchain processing for a set period of time, or to complete a certain level of blockchain processing or related computations or processing, by way of non-limiting examples. In this regard, the method 100 may also include monitoring the duration of blockchain processor 48 use or the amount of energy consumed for such use, and terminating use of the blockchain processor 48 to ensure sufficient charging of the vehicle battery 28. The blockchain processor 48 use may be terminated when the energy available for continued charging of the vehicle 10 at that point in time is not greater than the amount of energy needed to reach (or exceed a predetermined threshold above) the energy target.

During a charge cycle, the vehicle battery 28 may be fully charged or at least reach a predetermined level of charge such that further charging of the battery 28 is either unwanted or could subject the battery 28 to overcharging. In these situations, more energy may be available from the power source than can be provided to the vehicle 10 during the charge cycle. Blockchain processing may be used to prevent battery overcharging or to use available energy that is not needed to charge the battery 28, that is, available energy beyond the energy target to achieve benefits from the blockchain processing. For example, when the vehicle battery 28 is above a predetermined charge level, or will be during the charge cycle, blockchain processing may be started as an alternative to wasting or not using energy available from the energy generator 32. That is, the blockchain processing and battery charging may both occur during a charge cycle when sufficient energy is available. When the blockchain processor 48 is mounted in the vehicle 10, the blockchain processor 48 is powered by the vehicle battery 28, which may be charging while the blockchain processing is occurring, to reach a desired charge level during the charge cycle. When the blockchain processor 48 is part of the charging system 30 outside of the vehicle 10, the blockchain processor 48 is powered by the power source which may include power from the energy generator 32 and/or batteries including stored power from the energy generator 32.

In some embodiments, blockchain processing may be initiated or stopped by a user of the vehicle 10. The vehicle 10 may display one or more aspects of the available energy or energy target to the user, allowing the user to make an educated decision on when blockchain processing should be performed. For example, the projected energy recapture of the vehicle 10 may be communicated to the user through known display or communication means within a vehicle 10. A projected range based on, for example, the battery charge level, the projected speed of the vehicle 10, the location of the vehicle 10, the projected route of the vehicle 10, and/or the projected amount of available energy from the energy generator among other parameters, may be communicated to the user.

Blockchain processing, once started, may be stopped at any time by a user, or by the control system 42 if one or more energy parameters change. For example, the battery charge level may decrease to a predetermined level of charge, the projected vehicle range may decrease, other vehicle accessories may require above a predetermined amount of energy, the projected vehicle route may be changed to a route requiring more energy, or the determined amount of available energy may decrease.

What is claimed is:

1. A method for using available energy from a vehicle charging system to power blockchain processing, comprising the steps of:
determining that a charge cycle for charging a vehicle battery is occurring;
determining an amount of available energy at least in part from an energy generator;
determining an energy target at least in part based on a charge level of the vehicle battery to be achieved during the charge cycle;
comparing the amount of available energy to the energy target; and
powering one or more blockchain processors to perform blockchain processing when the available energy meets or exceeds the energy target.

2. The method of claim 1, wherein the available energy includes stored energy from the energy generator and an amount of energy that is determined will be generated by the energy generator during the charge cycle.

3. The method of claim 1, wherein the energy target includes an amount of energy required to perform at least some blockchain processing in addition to the energy needed to charge the vehicle battery to the charge level to be achieved during the charge cycle.

4. The method of claim 1, wherein the energy generator is a renewable energy source including one or more of a solar panel, a wind turbine, a hydro-electric turbine, a tidal generator, and a wave energy convertor.

5. The method of claim 4, wherein the energy generator is coupled to a vehicle battery charger or to an energy storage device that is coupled to the vehicle battery charger.

6. The method of claim 1, wherein the step of powering one or more blockchain processors to perform blockchain processing includes using power from the energy generator to power the one or more blockchain processors.

7. The method of claim 1, wherein the energy generator is carried by the vehicle.

8. The method of claim 1, wherein the energy generator is separate from the vehicle and is selectively brought into electric communication with the vehicle battery.

9. The method of claim 1, wherein the step of powering one or more blockchain processors to perform blockchain processing includes using power from the vehicle battery to power the one or more blockchain processors.

10. The method of claim 1, wherein performing blockchain processing includes collecting unconfirmed transactions from a network;
organizing transactions into a new block, referring to previous block creating chain of blocks; and
producing a hash that meets specific criteria of a blockchain.

11. A system for a vehicle, comprising:
a blockchain processor;
a vehicle battery adapted to be charged with electrical power from a vehicle battery charger;
a control system communicated with the vehicle battery to control, at least in part, charging of the vehicle battery, the control system includes one or more processors, memory and instructions or programs stored in the memory or otherwise accessible by the processors that is capable of communicating with a network configured to transmit and receive blockchain data, wherein the blockchain processor is either integrated with the controller or separate from the controller and is capable of communicating with the controller to:
determine that a charge cycle for charging the vehicle battery is occurring;
determine an amount of available energy at least in part from an energy generator;
determine an energy target at least in part based on a charge level of the vehicle battery to be achieved during the charge cycle;
compare the amount of available energy to the energy target; and
power the blockchain processor to perform blockchain processing when the available energy meets or exceeds the energy target.

12. The system of claim 11, wherein the control system is adapted to communicate with the vehicle battery charger, and wherein the available energy includes stored energy available to the vehicle battery charger and an amount of energy that is determined will be generated by an energy generator coupled to the vehicle battery charger during the charge cycle.

13. The system of claim 11, wherein the energy target includes an amount of energy required to perform at least some blockchain processing in addition to the energy needed to charge the vehicle battery to the charge level to be achieved during the charge cycle.

14. The system of claim 12, wherein the energy generator is a renewable energy source including one or more of a solar panel, a wind turbine, a hydro-electric turbine, a tidal generator, and a wave energy convertor.

15. The system of claim 14, wherein the energy generator is coupled to the vehicle battery charger or to an energy storage device that is coupled to the vehicle battery charger.

16. The system of claim 11, wherein the step of powering one or more blockchain processors to perform blockchain processing includes using power from the vehicle battery charger to power the one or more blockchain processors.

17. The system of claim 12, wherein the energy generator includes one or both of a solar panel or a wind turbine, and the energy generator is carried by the vehicle.

18. The system of claim 11, wherein the step of powering one or more blockchain processors to perform blockchain processing includes using power from the vehicle battery to power the one or more blockchain processors.

19. The system of claim 15, wherein the energy generator is dedicated at least in part to the vehicle battery charger.
